(19) United States
(12) Patent Application Publication
(10) Pub. No.: US 2011/0141758 A1
(43) Pub. Date: Jun. 16, 2011

(54) OPTICAL COUPLER AND ACTIVE OPTICAL MODULE COMPRISING THE SAME

(75) Inventors: Hong-Seok SEO, Daejeon (KR); Joon Tae Ahn, Daejeon (KR); Bong Je Park, Daejeon (KR); Dae Kon Oh, Daejeon (KR); Jung-Ho Song, Daejeon (KR)

(73) Assignee: ELECTRONICS AND TELECOMMUNICATIONS RESEARCH INSTITUTE, Daejeon (KR)

(21) Appl. No.: 12/949,447

(22) Filed: Nov. 18, 2010

(30) Foreign Application Priority Data
Dec. 16, 2009 (KR) 10-2009-0125473

(51) Int. Cl. H01S 3/00; G02B 6/26

(52) U.S. Cl. 362/553; 385/43

(57) ABSTRACT

Provided are an optical coupler, which can improve miniaturization and integration, and an active optical module comprising the same. The optical coupler comprises a hollow optical block having a through hole formed to pass an optical fiber therethrough. The hollow optical block comprises at least one incidence plane, at least one internal reflection plane, and at least one tapering region. The incidence plane is disposed at the bottom of the hollow optical block, which is parallel to the through hole, to incident-transmit light. The internal reflection plane is disposed at the top of the hollow optical block, which is opposite to the incidence plane, to reflect the light, which is received from the incidence plane, into the hollow optical block. The tapering region is configured to concentrate the light on the optical fiber in the through hole. The tapering region is formed such that the outer diameter of the hollow optical block decreases away from the internal reflection plane and the incidence plane.

### CROSS-REFERENCE TO RELATED APPLICATIONS

This U.S. non-provisional patent application claims priority under 35 U.S.C. §119 of Korean Patent Application No. 10-2009-0125473, filed on Dec. 16, 2009, the entire contents of which are hereby incorporated by reference.

### BACKGROUND OF THE INVENTION

The present invention disclosed herein relates to an optical coupler and an active optical module comprising the same, and more particularly, to an optical coupler, which is to transmit pump light to an optical fiber, and an active optical module comprising the same.

Optical communication is improving data communication and information processing speed. A single-wavelength laser beam is mainly used as a light source for optical communication. Laser beams may be radiated by various lasers. Examples of the lasers for optical communication may comprise surface-emitting lasers and fiber-optic lasers. A fiber-optic laser may comprise an optical fiber with a double cladding structure. The fiber-optic laser may generate a laser beam by applying pump light to a core with an active medium. Thus, a high-power fiber-optic laser may be implemented by efficiently supplying pump light to the core of an optical fiber.

### SUMMARY OF THE INVENTION

The present invention provides an optical coupler, which can efficiently supply pump light to the core of an optical fiber, and an active optical module comprising the same.

The present invention also provides an optical coupler, which can be easily coupled to an optical fiber, and an active optical module comprising the same.

In some embodiments of the present invention, optical couplers comprise: a hollow optical block having a through hole formed to pass an optical fiber therethrough, the hollow optical block comprising: at least one incidence plane transmitting a light at the bottom of the hollow optical block, which is parallel to the through hole; at least one internal reflection plane reflecting the light transmitted from the incidence plane, the internal reflection plane being formed of the top of the hollow optical block opposite to the incidence plane; and at least one tapering region concentrating the light on the optical fiber in the through hole, the tapering region decreased continuously a outer diameter of the hollow optical block far from the internal reflection plane and the incidence plane.

In some embodiments, the internal reflection plane comprises at least one inclined plane reflecting the light to the tapering region.

In other embodiments, the inclined plane totally-reflects or reflects the light transmitted through the incidence plane.

In further embodiments, the inclined plane comprises a groove.

In still further embodiments, the inclined plane comprises a slope inclined plane formed across the through hole from the top of the through hole to the bottom of the through hole.

In other embodiments of the present invention, active optical modules comprise: a pump light source supplying a light; an optical fiber comprising a core containing an active material for generating a laser beam by the light received from the pump light source, and a first cladding enclosing the core; a hollow optical block comprising a through hole formed to pass an optical fiber therethrough, at least one incidence plane transmitting a light at the bottom of the hollow optical block, which is parallel to the through hole, at least one internal reflection plane reflecting the light transmitted from the incidence plane, the internal reflection plane being formed of the top of the hollow optical block opposite to the incidence plane, at least one tapering region concentrating the light on the optical fiber in the through hole, the tapering region decreased continuously a outer diameter of the hollow optical block far from the internal reflection plane and the incidence plane; a first optical device formed at one end of the optical fiber penetrating the optical coupler; and a second optical device formed at the other end of the optical fiber opposite to the first optical device, to emit the laser beam generated in the optical fiber.

### BRIEF DESCRIPTION OF THE DRAWINGS

The accompanying drawings are comprised to provide a further understanding of the present invention, and are incorporated in and constitute a part of this specification. The drawings illustrate exemplary embodiments of the present invention and, together with the description, serve to explain principles of the present invention. In the drawings:

FIGS. 1 and 2 are perspective views of an optical coupler and an optical fiber coupled to the optical coupler according to exemplary embodiments of the present invention;

FIGS. 3 and 4 are diagrams illustrating the cross section of the optical coupler of FIGS. 1 and 2 and the traveling direction of pump light;

FIGS. 5 and 6 are diagrams illustrating an optical coupler according to other exemplary embodiments of the present invention;

FIGS. 7A to 7D are schematic diagrams illustrating an active optical module according to an exemplary embodiment of the present invention;

FIGS. 8A to 8D are schematic diagrams illustrating an active optical module according to another exemplary embodiment of the present invention;

FIGS. 9A to 9D are schematic diagrams illustrating an active optical module according to another exemplary embodiment of the present invention; and

FIGS. 10A to 10D are schematic diagrams illustrating an active optical module according to another exemplary embodiment of the present invention.

### DETAILED DESCRIPTION OF PREFERRED EMBODIMENTS

Preferred embodiments of the present invention will be described below in more detail with reference to the accompanying drawings. Advantages and features of the present invention will be clarified through the following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

It will be understood that when a layer (or film) is referred to as being on another layer or substrate, it can be directly on the other layer or substrate, or one or more intervening layers may also be present. In the drawings, the dimensions of layers (or films) and regions are exaggerated for clarity of illustration. Although terms like a first, a second, and a third are used to describe various regions and layers (or films) in various embodiments of the present invention, the regions and the layers are not limited by these terms. These terms are used only to discriminate one region or layer from another region or layer. An embodiment described and exemplified herein comprises a complementary embodiment thereof.

Hereinafter, a laser module according to an exemplary embodiment of the present invention will be described in detail with reference to the accompanying drawings.

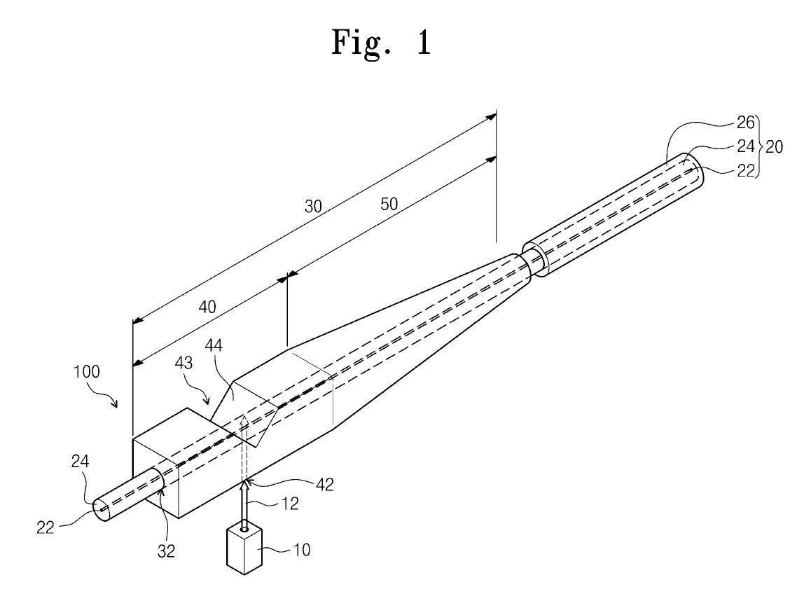

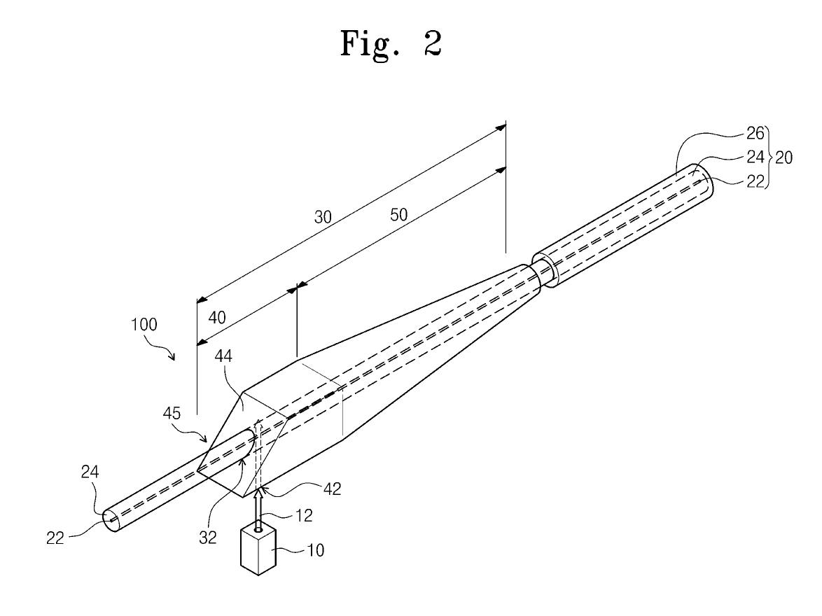

FIGS. 1 and 2 are perspective views of an optical coupler and an optical fiber coupled to the optical coupler according to exemplary embodiments of the present invention.

Referring to FIGS. 1 and 2, an optical coupler 100 according to an exemplary embodiment of the present invention may comprise a hollow optical block 30 with a through hole 32 formed to pass an optical fiber 20 therethrough. The hollow optical block 30 may be welded to the optical fiber 20 inserted in the through hole 32. The hollow optical block 30 may comprise a transmission/reflection region 40 formed at one side thereof, and a tapering region 50 formed at the other side thereof.

The transmission/reflection region 40 may comprise an incidence plane 42 formed at the bottom of the hollow optical block 30 to transmit pump light 12, which is perpendicularly incident thereon, and an internal reflection plane 44 formed at the top of the hollow optical block 30 opposite to the incidence plane 42. The internal reflection plane 44 may comprise a V-shaped groove 43 and/or a slope inclined plane 45. Herein, the V-shaped groove 43 may have two inclined planes, and the slop inclined plane 45 may have one inclined plane. The pump light 12 may be incident on the internal reflection plane 44. Thus, the internal reflection plane 44 may totally reflect the pump light 12, which is perpendicularly incident on the optical fiber 20 through the incidence plane 42 of the hollow optical block 30, in parallel to the optical fiber 20 without refracting the pump light 12 into the air.

The tapering region 50 may concentrate the pump light 12, which is totally reflected by the internal reflection plane 44, on the optical fiber 20. Also, the tapering region 50 may totally reflect the pump light 12, which is totally reflected by the internal reflection plane 44, to the optical fiber 20. The outer diameter of the hollow optical block 30 of the tapering region 50 may decrease far from the transmission/reflection region 40 along the optical fiber 20 inserted in the through hole 32. The outer diameter of the end of the tapering region 50 may be equal to the outer diameter of the optical fiber 20. The tapering region 50 may extend to such a length as to minimize the pump light coupling loss.

The optical fiber 20 may comprise a core 22 formed at the center thereof, and at least one cladding that encloses the core 22. The core 22 may have a higher refractivity than the cladding. For example, the optical fiber 20 may comprise a double cladding optical fiber that has a core 22 enclosed sequentially by a first cladding 24 and a second cladding 26. Herein, the through hole 32 of the hollow optical block 30 may be formed to pass the core 22 and the first cladding 24 of the optical fiber 20 having the second cladding 26 removed.

The core 22 may have a smaller cross-sectional area than the first cladding 24. The core 22 has a higher refractivity than the first cladding 24 and the second cladding 26. Also, the core 22 may further comprise active materials such as rare earth elements that absorb the pump light 12 to radiate laser beams. The rare earth elements may be amplified spontaneous emission (ASE). The rare earth elements may absorb the pump light 12 to emit single-wavelength laser beams by the stabilization of electrons excited to metastable states.

The first cladding 24 and the second cladding 26 may comprise fluorinated polymer or glass that has a lower refractivity than the core 22. The first cladding 24 may have a higher refractivity than the second cladding 26. For example, the first cladding 24 may comprise silica glass, and the second cladding may comprise fluorinated polymer. The second cladding 26 may be easily removed from the first cladding 24. The first cladding 24 and the second cladding 26 may have a circular or polygonal cross section.

A pump light source 10 may comprise a laser diode that radiates the pump light 12 by receiving an external power supply voltage. The laser diode may be a bar type, a stack type or a single emitter type. The pump light source 10 may radiate the pump light 12 with at least one wavelength band of 808 nm, 915 nm, 950 nm, 980 nm or 1470 nm depending on the type of a light emitting material.

The pump light 12 may be totally reflected when traveling from a high-refractive medium into a low-refractive medium, and may be totally transmitted without reflection when traveling between different mediums with similar refractive indexes. For example, the first cladding 24 and the core 22 of the optical fiber 20 may be inserted into the through hole 32 of the hollow optical block 30. The hollow optical block 30 may be formed of a transparent material that has an identical or similar refractivity to the first cladding 24 inserted into the through hole 32.

Thus, the optical coupler 100 according to an exemplary embodiment of the present invention can efficiently supply the pump light 12, which is perpendicularly incident on the optical fiber 20, to the core of the optical fiber 20. Also, the first cladding 24 and the core 22 of the optical fiber 20 can be easily inserted into the through hole 32 of the optical coupler 100 after being isolated from the second cladding 26.

The transmission/reflection region 40 may have a tetragonal or circular cross section. Also, the through hole 32 and the optical fiber 20 may have the same circular shape and the same diameter. The tapering region 50 may have a tetragonal or circular cross section.

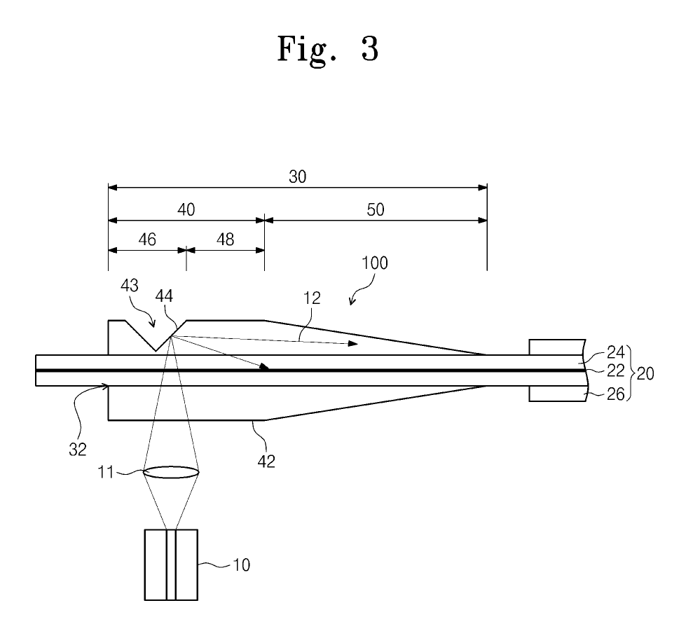

FIGS. 3 and 4 are diagrams illustrating the cross section of the optical coupler 100 of FIGS. 1 and 2 and the traveling direction of the pump light 12.

Referring to FIGS. 3 and 4, the optical coupler 100 according to an exemplary embodiment of the present invention may totally reflect the pump light 12, which is perpendicularly incident on the optical fiber 20 in the transmission/reflection region 40, to the optical fiber 20. Herein, the transmission/reflection region 40 may be divided into an inclined region 46 and a horizontal region 48. The inclined region 46 may comprise an incidence plane 42 and an internal reflection plane 44. The incidence plane 42 may transmit the pump light 12. The internal reflection plane 44 may comprise a V-shaped groove 43 and/or a slope inclined plane 45 that internally reflects the pump light 12 in the inclined region 46.

The incidence plane 42 may be formed to be flat in the direction parallel to the through hole 32. On the other hand, the internal reflection plane 44 may comprise at least one inclined plane that is formed in the direction across the through hole 32. Thus, the inclined region 46 may be formed such that the internal reflection plane 44 makes an acute angle with the incidence plane 42. The pump light 12 supplied by the pump light source 10 may be incident/transmitted at an incidence angle to the incidence plane 42. For example, when the pump light 12 is perpendicularly incident on the incidence plane 42, it may travel straight from the pump light source to the internal reflection plane 44.

The pump light 12 may reach the internal reflection plane 44 through the optical fiber 20 inserted in the through hole 32. At this point, the amount of the pump light 12 absorbed by the core 22 of the optical fiber 20 may be very small.

This is because the planar area of the optical fiber 20 is very smaller than the planar area of the incidence plane 42 and the internal reflection plane 44. This may also be because the planar area of the core 22 of the optical fiber 20 is smaller than the cross-sectional area of the pump light 12 traveling in the hollow optical block 30. The pump light 12 generated by the pump light source 10 may be focused by a lens 11 before being incident on the incidence plane 42.

Most of the pump light 12 transmitted through the incidence plane 42 may be totally internally reflected by the internal reflection plane 44. The internal reflection plane 44 may totally reflect the pump light 12 to the optical fiber 20. For example, the internal reflection plane 44 may comprise a coating material such as a dielectric and a metal that reflect the pump light 12. Thus, it can be seen that the inclined region 46 is a first total reflection region that totally reflects the transmitted pump light 2 in the hollow optical block 30 first.

The horizontal region 48 may be formed between the inclined region 46 and the tapering region 50. The horizontal region 48 may transmit the pump light 12, which is internally reflected by the internal reflection plane 44 of the inclined region 46, to the tapering region 50. The surface of the hollow optical block 30 of the horizontal region 48 may totally reflect the pump light 12 to the tapering region 50. At this point, the pump light 12 reflected by the internal reflection plane 44 may be incident on the surface of the hollow optical block 30 of the horizontal region 48 at an incidence angle smaller than the critical angle. The horizontal region 48 may totally reflect the pump light 12, which is received from the inclined region 46, to the tapering region 50.

The tapering region 50 may be formed such that the outer diameter of the hollow optical block 30 decreases away from the transmission/reflection region 40 with the optical fiber 20 centered to be inserted in the through hole 32. Thus, the tapering region 50 may concentrate the pump light 12, which is received from the inclined region 46 and the horizontal region 48, on the optical fiber 20 by totally reflecting the received pump light 12. At this point, the pump light 12 may be totally reflected in the hollow optical block 30 in a single direction. Thus, the optical coupler 100 according to exemplary embodiments of the present invention can totally reflect the pump light 12 in a single direction with respect to the tapering region 50 formed at one side of the hollow optical block 30.

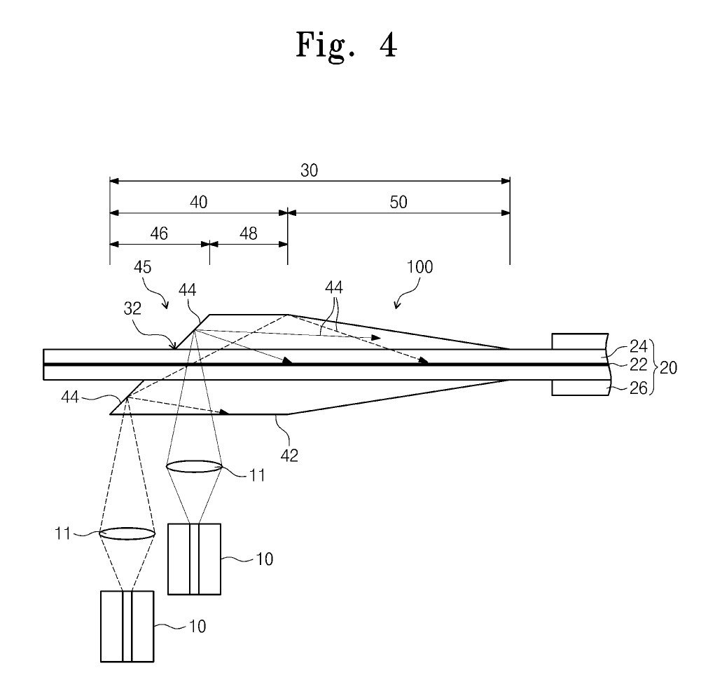

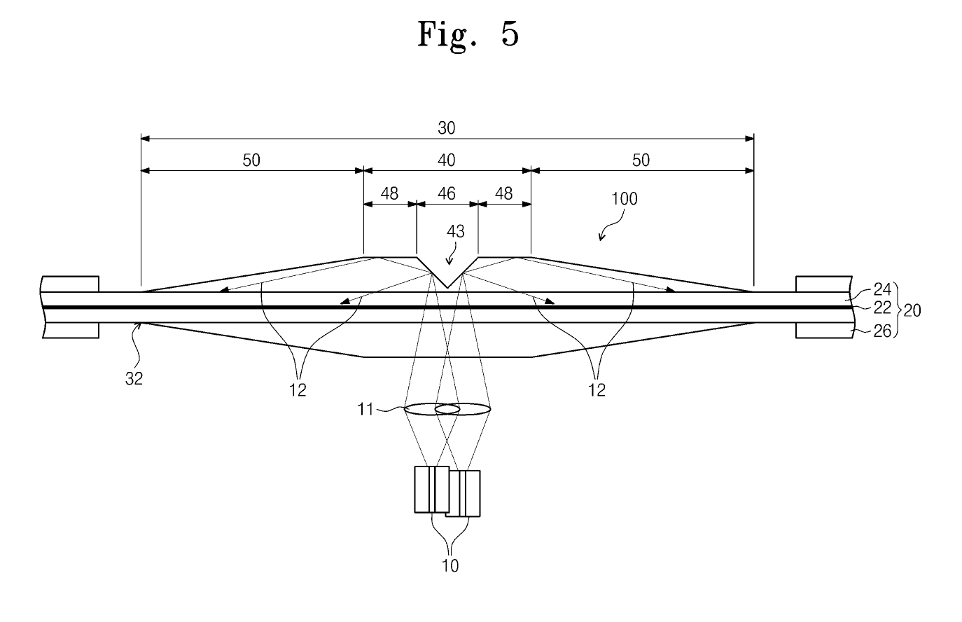

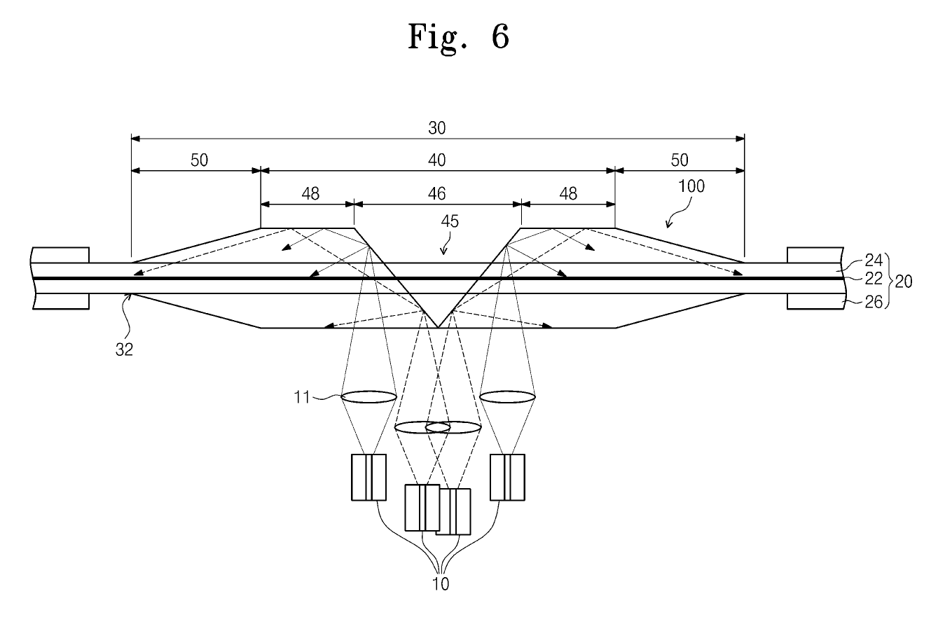

FIGS. 5 and 6 are diagrams illustrating an optical coupler according to other exemplary embodiments of the present invention.

Referring to FIGS. 5 and 6, an optical coupler 100 according to other exemplary embodiments of the present invention may supply pump light 12, which is generated by a plurality of pump light sources 10, to both ends of an optical fiber 20. A plurality of tapering regions 50 may be formed at both sides of a transmission/reflection region 40. The transmission/reflection region 40 may comprise an reflection region 46 and a plurality of horizontal regions 48. The reflection region 46 may comprise a plurality of inclined planes inclined in different directions. The plurality of horizontal regions 48 may be formed at both sides of the reflection region 46. The inclined planes and the horizontal regions 48 may be formed to be symmetrical. Herein, at least one of the inclined planes and the horizontal regions 48 may not be formed to be symmetrical. The pump light sources 10 may comprise at least one lens 11 that focuses the pump light 12 on the inclined planes.

The reflection region 46 may comprise a V-shaped groove 43 and/or a plurality of slope inclined planes 45. Herein, the slope inclined planes 45 may comprise an inclined plane that is formed from the top of a hollow optical block 30 through a through hole 32 to the bottom of the hollow optical block 30. The V-shaped groove 43 and the slope inclined planes 45 may comprise a plurality of inclined planes formed in the opposite directions. The pump light 12 supplied by the pump light sources 10 may be internally reflected by the inclined planes in different directions. The pump light 12 may be concentrated in both directions of the optical fiber 20 through a plurality of tapering regions 50. Thus, the optical coupler 100 according to exemplary embodiments of the present invention can transmit the pump light 12 in both directions of the optical fiber 20 through the tapering regions 50 formed at both sides of the hollow optical block 30.

The optical coupler 100 according to exemplary embodiments of the present invention may be used to implement a fiber-optic amplifier and a fiber-optic laser having a unidirectional pumping mode or a bidirectional pumping mode depending on the number of tapering regions 50. The type of an active optical module may depend on the types of optical devices formed at both ends of the optical fiber 20 coupled to the optical coupler 100. An active optical module may be divided into a fiber-optic laser and a fiber-optic amplifier.

Hereinafter, a description will be given of an active optical module having a unidirectional pumping mode and/or a bidirectional pumping mode depending on the types of optical devices connected to the optical fiber 20 and the optical coupler 100.

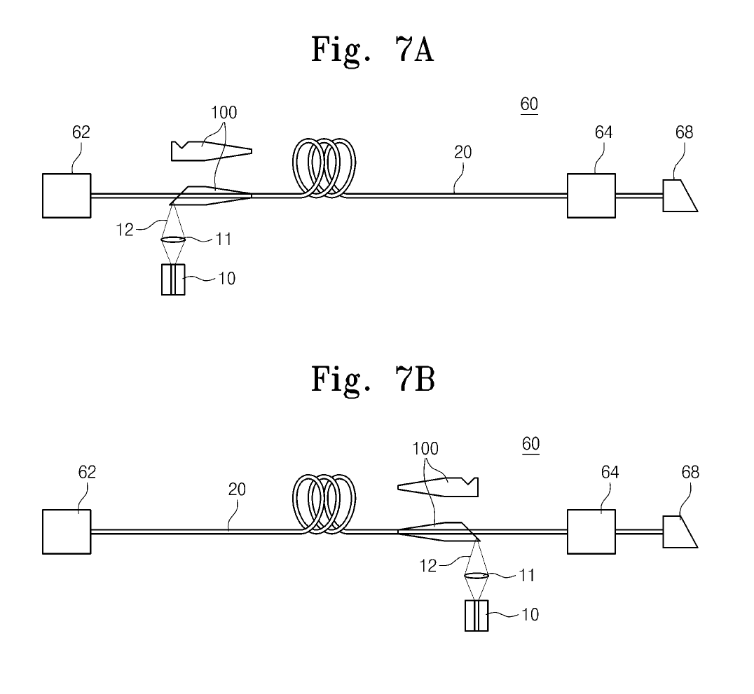

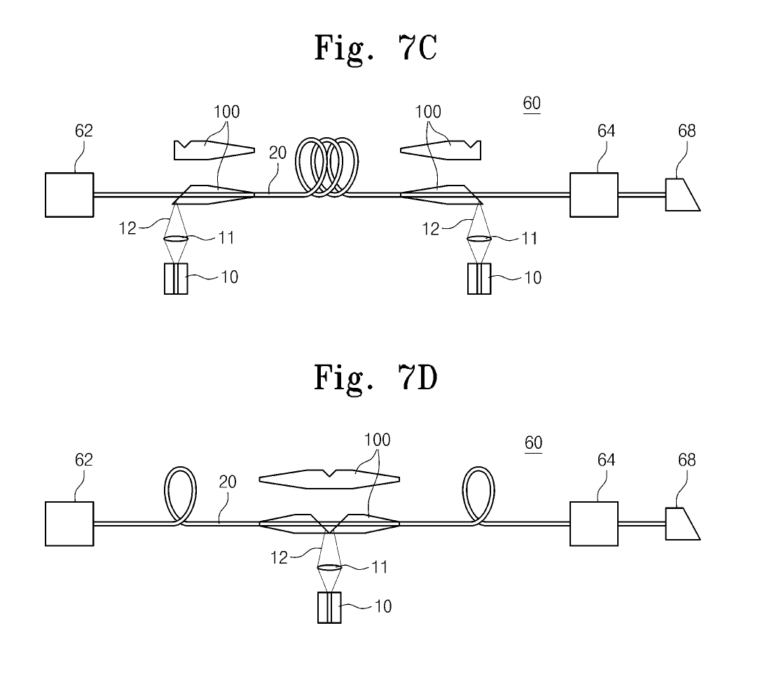

FIGS. 7A to 7D are schematic diagrams illustrating an active optical module according to an exemplary embodiment of the present invention.

Referring to FIGS. 7A to 7D, an active optical module according to an exemplary embodiment of the present invention may comprise a continuous output laser having first and second mirrors 62 and 64 formed respectively in both ends of the optical fibers 20 penetrating the optical coupler 100 described with reference to FIGS. 1 and 2. The continuous output laser may radiate a laser beam with a single wavelength. Specifically, the core 22 of the optical fiber 20 between the first and second mirrors 62 and 64 may radiate a laser beam by the pump light 12. After being generated by the pump light source 10, the pump light 12 may be incident on the optical fiber 20 through the lens 11.

The first and second mirrors 62 and 64 may resonate the laser beam radiated by the optical fiber 20. The first mirror 62 may reflect about 100% of a laser beam, and the second mirror 64 may reflect about 5% to about 20% of the laser beam. The first mirror 62 may comprise a Fiber Bragg Grating (FBG) or a full mirror that totally reflects the laser beam. The second mirror 64 may comprise an output coupler or an FBG that transflects the laser beam. The laser beam radiated between the first mirror 62 and the second mirror 64 may be outputted to a collimator or an end cap 68 through a pigtail optical fiber extending from the second mirror 64.

Referring to FIG. 7A, the active optical module according to an exemplary embodiment of the present invention may have a forward pumping mode where the tapering region 50 of the optical coupler 100 is formed in the direction from the first mirror 62 to the second mirror 64. The laser beam may be outputted to the end cap 68 through the pigtail optical fiber extending from the second mirror 64. The optical coupler 100 may be coupled to the optical fiber 20 adjacent to the first mirror 62. The pump light 12 supplied through the optical coupler 100 to the optical fiber 20 may be sufficiently absorbed while traveling along the optical fiber 20 extending from the first mirror 62 to the second mirror 64. Thus, in the forward pumping mode, the traveling direction of the pump light 12 in the optical fiber 20 may be identical to the traveling direction of the laser output beam.

Referring to FIG. 7B, the active optical module according to an exemplary embodiment of the present invention may have a backward pumping mode where the tapering region 50 of the optical coupler 100 is formed in the direction from the second mirror 64 to the first mirror 62. The optical coupler 100 may be coupled to the optical fiber 20 adjacent to the second mirror 64. The pump light 12 supplied through the optical coupler 100 to the optical fiber 20 may be sufficiently absorbed while traveling along the optical fiber 20 extending from the second mirror 64 to the first mirror 62. Thus, in the backward pumping mode, the traveling direction of the pump light 12 in the optical fiber 20 may be opposite to the traveling direction of the laser output beam.

Referring to FIG. 7C, the active optical module according to an exemplary embodiment of the present invention may have an edge bidirectional pumping mode where a plurality of optical couplers 100 are formed at optical fibers 20 adjacent respectively to the first mirror 62 and the second mirror 64. The tapering region 50 of the optical coupler 100 adjacent to the first mirror 62 may be formed in the direction of the second mirror 64, and the tapering region 50 of the optical coupler 100 adjacent to the second mirror 64 may be formed in the direction of the first mirror 62. Thus, the tapering regions 50 of the optical coupler 100 may be formed in the opposite directions. The pump light 12 supplied through the optical couplers 100 may be sufficiently absorbed while traveling along the optical fiber 20 between the first mirror 62 and the second mirror 64.

Referring to FIG. 7D, the active optical module according to an exemplary embodiment of the present invention may have a center bidirectional pumping mode where the optical coupler 100 with a plurality of tapering regions 50 is formed at the center of the optical fiber 20 between the first mirror 62 and the second mirror 64. The optical coupler 100 may transmit a plurality of pump lights 12 to the optical fiber 20 in the directions of the first mirror 62 and the second mirror 64 through the tapering regions 50 formed at both sides thereof. The optical fiber 20 may extend to such a length that the pump light 12 transmitted to both sides of the optical coupler 100 can be sufficiently absorbed by the core 22. The pump light source 10 may comprise a single unit that supplies a single pump light 12 divided by the optical coupler 100. Also, the pump light source 10 may comprise a plurality of units that supply different pump lights 12 to both sides of the optical coupler 100. The center bidirectional pumping mode can transmit a plurality of pump lights 12 from the center of the optical fiber 20 to the first mirror 62 and the second mirror 64.

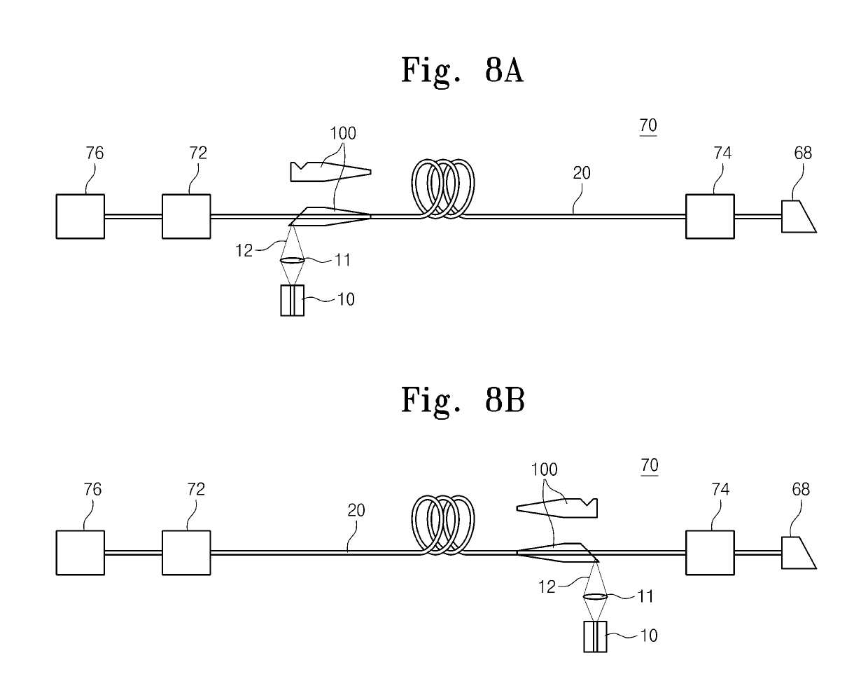

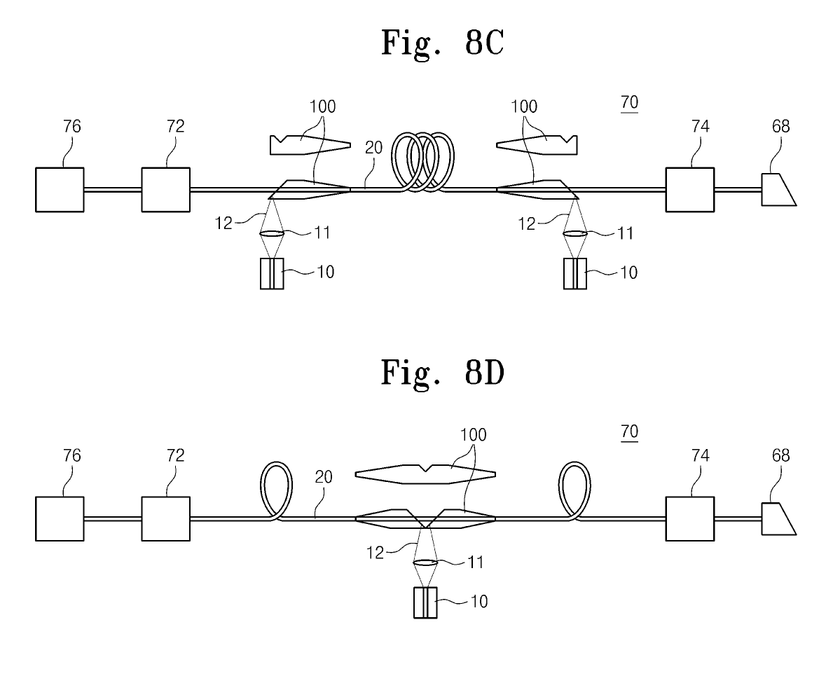

FIGS. 8A to 8D are schematic diagrams illustrating an active optical module according to another exemplary embodiment of the present invention.

Referring to FIGS. 8A to 8D, an active optical module according to another exemplary embodiment of the present invention may comprise a Q switching laser or a mode locking laser having a first mirror 62 and a modulator 96 formed at the optical fiber 20 in one side of the optical coupler 100 of FIGS. 1 and 2, and a second mirror 64 formed at the optical fiber 20 in the other side of the optical coupler 100. The Q switching laser or the mode locking laser may radiate a pulse laser beam. The core 22 of the optical fiber 20 between the first and second mirrors 62 and 64 may radiate a laser beam. The first and second mirrors 62 and 64 may resonate the laser beam.

The modulator 96 may modulate the laser beam with an analog or digital electrical signal. The modulator 96 may generate a pulse laser beam by switching the laser beam resonated between the first mirror 62 and the second mirror 64. The pulse laser beam may be generated according to a periodic on/off operation of the modulator 96. For example, the pulse laser beam may be generated when the modulator 96 is turned on, and it may not be generated when the modulator 96 is turned off.

The first mirror 62 may reflect about 100% of the laser beam, and the second mirror 64 may reflect about 5% to about 20% of the laser beam. The first mirror 62 may comprise a Fiber Bragg Grating (FBG) or a full mirror that totally reflects the laser beam. The second mirror 64 may comprise an output coupler or an FBG that transflects the laser beam. The pulse laser beam resonated between the first mirror 62 and the second mirror 64 may be outputted to a collimator or an end cap 68 through a pigtail optical fiber extending from the second mirror 64.

Referring to FIG. 8A, the active optical module according to another exemplary embodiment of the present invention may have a forward pumping mode where the tapering region 50 of the optical coupler 100 is formed in the direction from the first mirror 62 to the second mirror 64. Herein, the pulse laser beam may be outputted to the end cap 68 through the pigtail optical fiber extending from the second mirror 64. The optical coupler 100 may be coupled to the optical fiber 20 adjacent to the first mirror 62. The pump light 12 supplied through the optical coupler 100 to the optical fiber 20 may be sufficiently absorbed while traveling along the optical fiber 20 extending from the first mirror 62 to the second mirror 64. Thus, in the forward pumping mode, the traveling direction of the pump light 12 in the optical fiber 20 may be identical to the traveling direction of the pulse laser output beam.

Referring to FIG. 8B, the active optical module according to another exemplary embodiment of the present invention may have a backward pumping mode where the tapering region 50 of the optical coupler 100 is formed in the direction from the second mirror 64 to the first mirror 62. The optical coupler 100 may be coupled to the optical fiber 20 adjacent to the second mirror 64. The pump light 12 supplied through the optical coupler 100 to the optical fiber 20 may be sufficiently absorbed while traveling along the optical fiber 20 extending from the second mirror 64 to the first mirror 62. Thus, in the backward pumping mode, the traveling direction of the pump light 12 in the optical fiber 20 may be opposite to the traveling direction of the pulse laser output beam.

Referring to FIG. 8C, the active optical module according to another exemplary embodiment of the present invention may have an edge bidirectional pumping mode where a plurality of optical couplers 100 are formed at optical fibers 20 adjacent respectively to the first mirror 62 and the second mirror 64. The tapering region 50 of the optical coupler 100 adjacent to the first mirror 62 may be formed in the direction of the second mirror 64, and the tapering region 50 of the optical coupler 100 adjacent to the second mirror 64 may be formed in the direction of the first mirror 62. Thus, the tapering regions 50 of the optical coupler 100 may be formed in the opposite directions. The pump light 12 supplied through the optical couplers 100 may be sufficiently absorbed while traveling along the optical fiber 20 between the first mirror 62 and the second mirror 64.

Referring to FIG. 8D, the active optical module according to another exemplary embodiment of the present invention may have a center bidirectional pumping mode where the optical coupler 100 with a plurality of tapering regions 50 is formed at the center of the optical fiber 20 between the first mirror 62 and the second mirror 64. The optical coupler 100 may transmit a plurality of pump lights 12 to the optical fiber 20 in the directions of the first mirror 62 and the second mirror 64 through the tapering regions 50 formed at both sides of the center of the optical fiber 20. The optical fiber 20 may extend to such a length that the pump light 12 transmitted to both sides of the optical coupler 100 can be sufficiently absorbed by the core 22. The pump light source 10 may comprise a single unit that supplies a single pump light 12 divided by the optical coupler 100. Also, the pump light source 10 may comprise a plurality of units that supply different pump lights 12 to both sides of the optical coupler 100. The center bidirectional pumping mode can transmit a plurality of pump lights 12 from the center of the optical fiber 20 to the first mirror 62 and the second mirror 64.

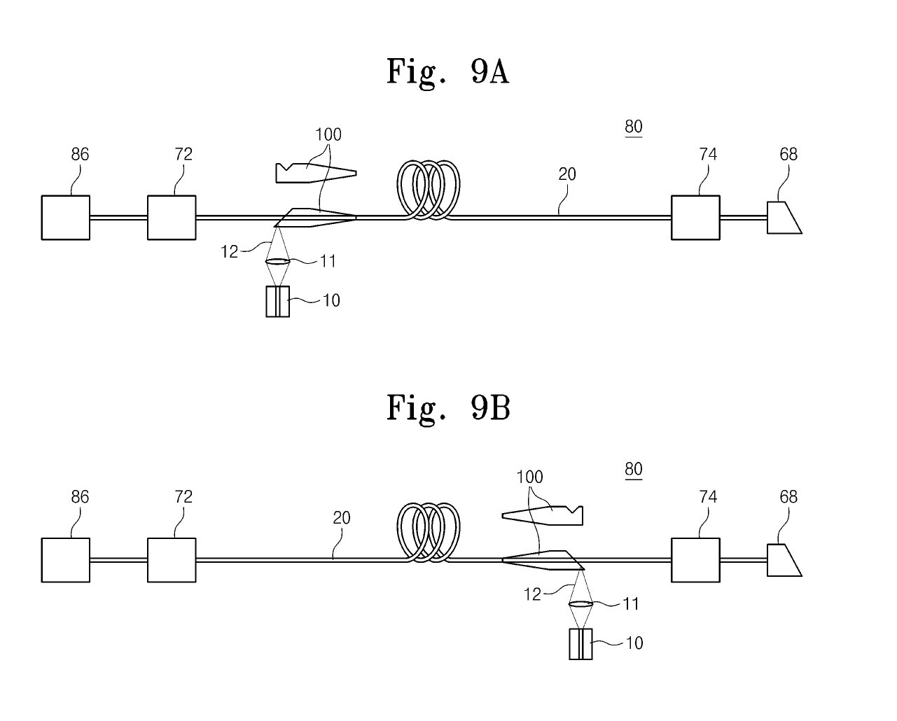

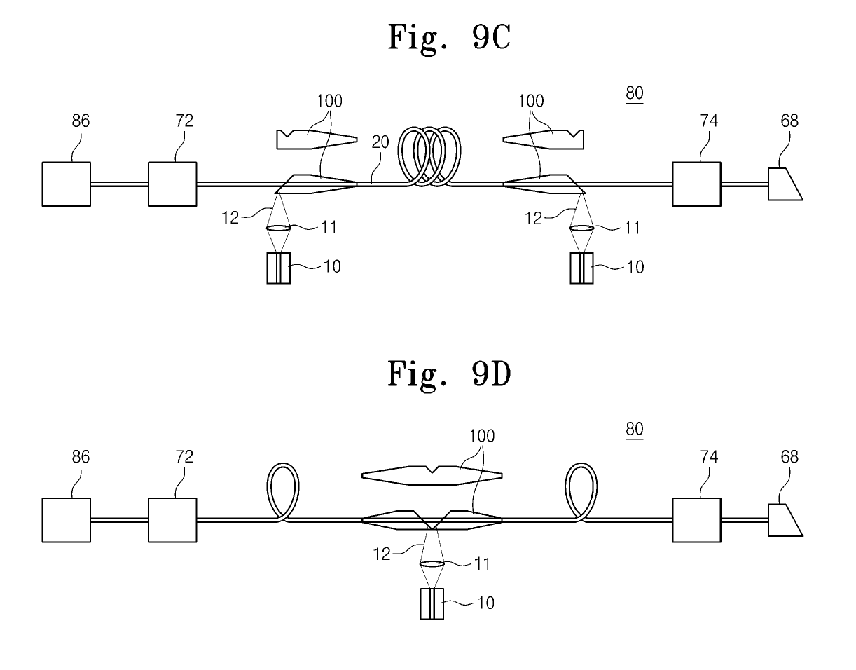

FIGS. 9A to 9D are schematic diagrams illustrating an active optical module according to another exemplary embodiment of the present invention.

Referring to FIGS. 9A to 9D, an active optical module according to another exemplary embodiment of the present invention may comprise a laser beam amplifier having a signal source and a first isolator 72 formed at one side of the optical coupler 100 of FIGS. 1 and 2, and a second isolator 74 formed at the other side of the optical coupler 100. The laser beam amplifier may amplify a laser beam by the pump light 12 received from the optical coupler 100. The signal source 76 may comprise a semiconductor light source, an output terminal of another fiber-optic amplifier, and a fiber-optic laser. After being generated by the pump light source 10, the pump light 12 may be incident on the optical fiber 20 through the lens 11. The output laser beam may be generated by amplifying the signal received from the signal source 76. Thus, the laser beam amplifier may output the laser beam amplified according to the signal of the signal source 76.

The first isolator 72 and the second isolator 74 may isolate the unwanted laser beam entered into the signal source 76. The first isolator 72 and the second isolator 74 may be disposed between the optical fibers spaced apart from each other by a predetermined distance or more. The laser beam may be outputted to a collimator or an end cap 68 through a pigtail optical fiber extending from the second isolator 74.

Referring to FIG. 9A, the active optical module according to another exemplary embodiment of the present invention may have a forward pumping mode where the tapering region 50 of the optical coupler 100 is formed in the direction from the first isolator 72 to the second isolator 74. Herein, the pulse laser beam may be outputted to the end cap 68 through the pigtail optical fiber extending from the second isolator 74. The optical coupler 100 may be coupled to the optical fiber 20 adjacent to the first isolator 72. The pump light 12 supplied through the optical coupler 100 to the optical fiber 20 may be sufficiently absorbed while traveling along the optical fiber 20 extending from the first isolator 72 to the second isolator 74. Thus, in the forward pumping mode, the traveling direction of the pump light 12 in the optical fiber 20 may be identical to the traveling direction of the output laser beam.

Referring to FIG. 9B, the active optical module according to another exemplary embodiment of the present invention may have a backward pumping mode where the tapering region 50 of the optical coupler 100 is formed in the direction from the second isolator 74 to the first isolator 72. The optical coupler 100 may be coupled to the optical fiber 20 adjacent to the second isolator 74. The pump light 12 supplied through the optical coupler 100 to the optical fiber 20 may be sufficiently absorbed while traveling along the optical fiber 20 extending from the second isolator 74 to the first isolator 72. Thus, in the backward pumping mode, the traveling direction of the pump light 12 in the optical fiber 20 may be opposite to the traveling direction of the output laser beam.

Referring to FIG. 9C, the active optical module according to another exemplary embodiment of the present invention may have an edge bidirectional pumping mode where a plurality of optical couplers 100 are formed at optical fibers 20 adjacent respectively to the first isolator 72 and the second isolator 74. Herein, the first isolator 72 and the second isolator 74 may isolate the laser beam traveling in the reverse direction. The tapering region 50 of the optical coupler 100 adjacent to the first isolator 72 may be formed in the direction of the second isolator 74, and the tapering region 50 of the optical coupler 100 adjacent to the second isolator 74 may be formed in the direction of the first isolator 72. Thus, the tapering regions 50 of the optical coupler 100 may be formed in the opposite directions. The pump light 12 supplied through the optical couplers 100 may be sufficiently absorbed while traveling along the optical fiber 20 between the first isolator 72 and the second isolator 74.

Referring to FIG. 9D, the active optical module according to another exemplary embodiment of the present invention may have a center bidirectional pumping mode where the optical coupler 100 with a plurality of tapering regions 50 is formed at the center of the optical fiber 20 between the first isolator 72 and the second isolator 74. The optical coupler 100 may transmit a plurality of pump lights 12 to the optical fiber 20 in the directions of the first isolator 72 and the second isolator 74 through the tapering regions 50. The optical fiber 20 may extend to such a length that the pump light 12 transmitted to both sides of the optical coupler 100 can be sufficiently absorbed by the core 22. The pump light source 10 may comprise a single unit that supplies a single pump light 12 divided by the optical coupler 100. Also, the pump light source 10 may comprise a plurality of units that supply different pump lights 12 to both sides of the optical coupler 100. The center bidirectional pumping mode can transmit a plurality of pump lights 12 from the center of the optical fiber 20 to the first isolator 72 and the second isolator 74.

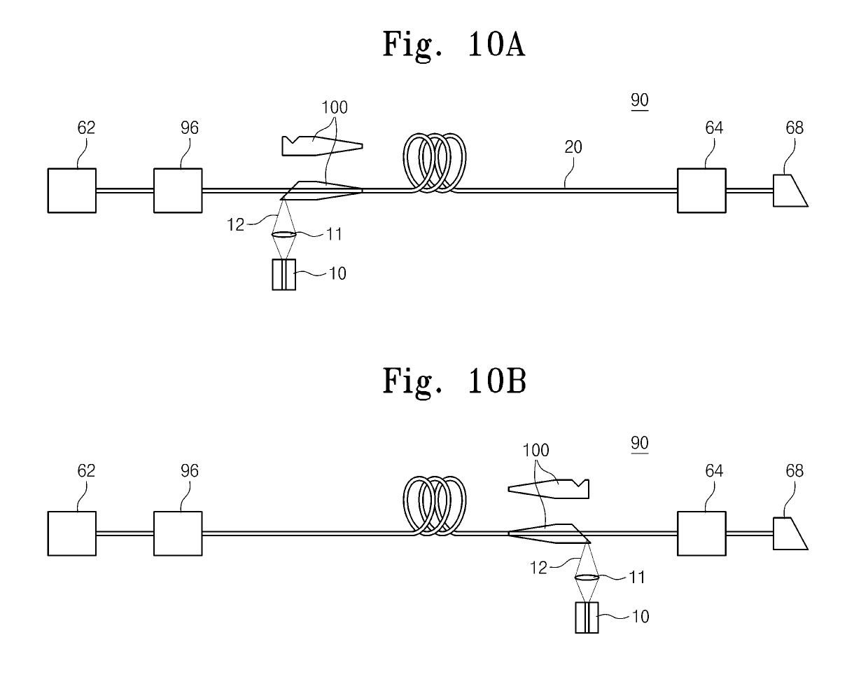

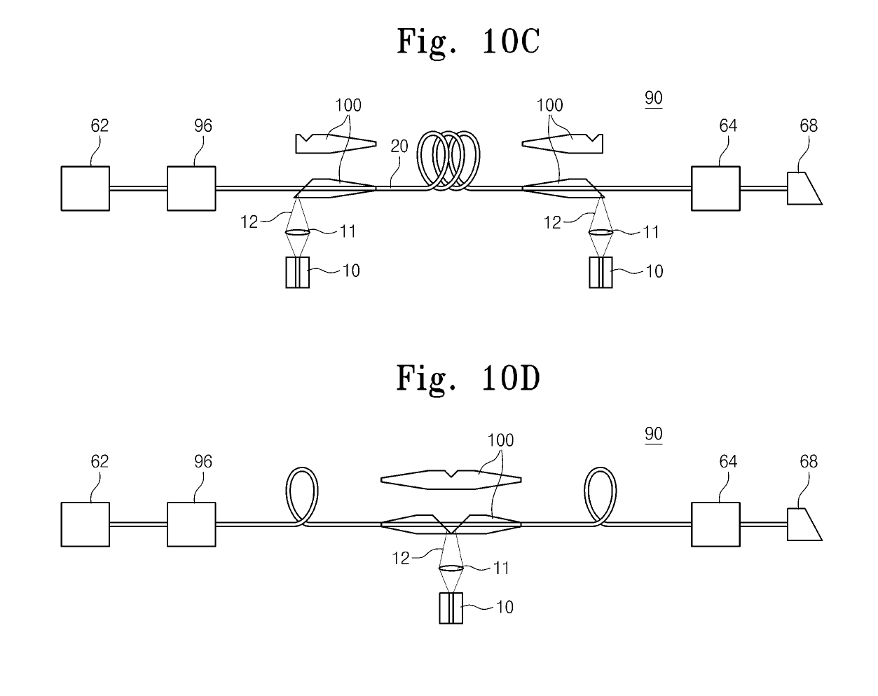

FIGS. 10A to 10D are schematic diagrams illustrating an active optical module according to another exemplary embodiment of the present invention.

Referring to FIGS. 10A to 10D, an active optical module according to another exemplary embodiment of the present invention may comprise a Master Oscillator Power Amplifier (MOPA) fiber-optic amplifier having a maser oscillator 86 and a first isolator 72 formed at one side of the optical coupler 100 of FIGS. 1 and 2, and a second isolator 74 formed at the other side of the optical coupler 100. The MOPA fiber-optic amplifier may amplify a laser beam by the pump light 12 received from the optical coupler 100. After being generated by the pump light source 10, the pump light 12 may be incident on the optical fiber 20 through the lens 11. The laser beam may be outputted as an output laser beam according to the signal of the master oscillator 86.

The first isolator 72 and the second isolator 74 may isolate the unwanted laser beam entered into the master oscillator 86. The first isolator 72 and the second isolator 74 may be disposed at the optical fibers spaced apart from each other by a predetermined distance or more. The laser beam may be outputted to a collimator or an end cap 68 through a pigtail optical fiber extending from the second isolator 74.

Referring to FIG. 10A, the active optical module according to another exemplary embodiment of the present invention may have a forward pumping mode where the tapering region 50 of the optical coupler 100 is formed in the direction from the first isolator 72 to the second isolator 74. Herein, the pulse laser beam may be outputted to the end cap 68 through the pigtail optical fiber extending from the second isolator 74. The optical coupler 100 may be coupled to the optical fiber 20 adjacent to the first isolator 72. The pump light 12 supplied through the optical coupler 100 to the optical fiber 20 may be sufficiently absorbed while traveling along the optical fiber 20 extending from the first isolator 72 to the second isolator 74. Thus, in the forward pumping mode, the traveling direction of the pump light 12 in the optical fiber 20 may be identical to the traveling direction of the output laser beam.

Referring to FIG. 10B, the active optical module according to another exemplary embodiment of the present invention may have a backward pumping mode where the tapering region 50 of the optical coupler 100 is formed in the direction from the second isolator 74 to the first isolator 72. The optical coupler 100 may be coupled to the optical fiber 20 adjacent to the second isolator 74. The pump light 12 supplied through the optical coupler 100 to the optical fiber 20 may be sufficiently absorbed while traveling along the optical fiber 20 extending from the second isolator 74 to the first isolator 72. Thus, in the backward pumping mode, the traveling direction of the pump light 12 in the optical fiber 20 may be opposite to the traveling direction of the output pulse laser beam.

Referring to FIG. 10C, the active optical module according to another exemplary embodiment of the present invention may have an edge bidirectional pumping mode where a plurality of optical couplers 100 are formed at optical fibers 20 adjacent respectively to the first isolator 72 and the second isolator 74. Herein, the first isolator 72 and the second isolator 74 may isolate the laser beam traveling in the reverse direction. The tapering region 50 of the optical coupler 100 adjacent to the first isolator 72 may be formed in the direction of the second isolator 74, and the tapering region 50 of the optical coupler 100 adjacent to the second isolator 74 may be formed in the direction of the first isolator 72. Thus, the tapering regions 50 of the optical coupler 100 may be formed in the opposite directions. The pump light 12 supplied through the optical couplers 100 may be sufficiently absorbed while traveling along the optical fiber 20 between the first isolator 72 and the second isolator 74.

Referring to FIG. 10D, the active optical module according to another exemplary embodiment of the present invention may have a center bidirectional pumping mode where the optical coupler 100 with a plurality of tapering regions 50 is formed at the center of the optical fiber 20 between the first isolator 72 and the second isolator 74. The optical coupler 100 may transmit a plurality of pump lights 12 to the optical fiber 20 in the directions of the first isolator 72 and the second isolator 74 through the tapering regions 50. The optical fiber 20 may extend to such a length that the pump light 12 transmitted to both sides of the optical coupler 100 can be sufficiently absorbed by the core 22. The pump light source 10 may comprise a single unit that supplies a single pump light 12 divided by the optical coupler 100. Also, the pump light source 10 may comprise a plurality of units that supply different pump lights 12 to both sides of the optical coupler 100. The center bidirectional pumping mode can transmit a plurality of pump lights 12 from the center of the optical fiber 20 to the first isolator 72 and the second isolator 74.

As described above, the exemplary embodiment of the present invention reflects pump light, which is perpendicularly incident on the optical fiber, at the internal reflection plane totally and concentrates the reflected light to the optical fiber in the tapering region, thereby making it possible to efficiently supply the pump light to the core of the optical fiber.

Also, the exemplary embodiment of the present invention isolates the first cladding and the core of the optical fiber from the second cladding, thus enabling them to be easily inserted into the through hole of the optical coupler.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An optical coupler comprising:
a hollow optical block having a through hole formed to pass an optical fiber therethrough, the hollow optical block comprising:
at least one incidence plane transmitting a light at the bottom of the hollow optical block, which is parallel to the through hole;
at least one internal reflection plane reflecting the light transmitted from the incidence plane, the internal reflection plane being formed of the top of the hollow optical block opposite to the incidence plane; and
at least one tapering region concentrating the light on the optical fiber in the through hole, the tapering region decreased continuously a outer diameter of the hollow optical block far from the internal reflection plane and the incidence plane.

2. The optical coupler of claim 1, wherein the internal reflection plane comprises at least one inclined plane reflecting the light to the tapering region.

3. The optical coupler of claim 2, wherein the inclined plane totally-reflects or reflects the light transmitted through the incidence plane.

4. The optical coupler of claim 2, wherein the inclined plane comprises a groove.

5. The optical coupler of claim 4, wherein the groove is V-shaped.

6. The optical coupler of claim 2, wherein the inclined plane comprises a slope inclined plane formed across the through hole from the top of the through hole to the bottom of the through hole.

7. The optical coupler of claim 2, further comprising a coating material formed at the inclined plane.

8. The optical coupler of claim 7, wherein the coating material comprises a metal or a dielectric.

9. The optical coupler of claim 1, wherein the hollow optical block of the internal reflection plane and the incidence plane has a tetragonal cross section.

10. The optical coupler of claim 1, wherein the through hole has a circular cross section.

11. An active optical module comprising:
a pump light source supplying a light;
an optical fiber comprising a core containing an active material for generating a laser beam by the light received from the pump light source, and a first cladding enclosing the core;
a hollow optical block comprising a through hole formed to pass an optical fiber therethrough, at least one incidence plane transmitting a light at the bottom of the hollow optical block, which is parallel to the through hole, at least one internal reflection plane reflecting the light transmitted from the incidence plane, the internal reflection plane being formed of the top of the hollow optical block opposite to the incidence plane, at least one tapering region concentrating the light on the optical fiber in the through hole, the tapering region decreased continuously a outer diameter of the hollow optical block far from the internal reflection plane and the incidence plane;
a first optical device formed at one end of the optical fiber penetrating the optical coupler; and
a second optical device formed at the other end of the optical fiber opposite to the first optical device, to emit the laser beam generated in the optical fiber.

12. The active optical module of claim 11, wherein the active optical module has a forward pumping mode where the tapering region of the optical coupler is formed in the direction from the first optical device to the second optical device.

13. The active optical module of claim 11, wherein the active optical module has a backward pumping mode where the tapering region of the optical coupler is formed in the direction from the second optical device to the first optical device.

14. The active optical module of claim 11, wherein the active optical module has an edge bidirectional pumping mode where the tapering regions are formed in the opposite directions.

15. The active optical module of claim 11, wherein the active optical module has a center bidirectional pumping mode where the tapering regions are formed in the directions of the first optical device and the second optical device.

16. The active optical module of claim 11, wherein the first optical device and the second optical device comprise a first mirror and a second mirror, respectively.

17. The active optical module of claim 16, further comprising a modulator formed at the optical fiber between the first mirror and the second mirror.

18. The active optical module of claim 11, wherein the first optical device and the second optical device comprise a first isolator and a second isolator, respectively

19. The active optical module of claim 18, further comprising a master oscillator or a signal source formed at the optical fiber outside the first isolator opposite to the second optical device.
